(19) United States
(12) Patent Application Publication
(10) Pub. No.: US 2022/0237615 A1
(43) Pub. Date: Jul. 28, 2022

(54) METHOD FOR PROVIDING PAYMENT SERVICE AND ELECTRONIC APPARATUS PERFORMING THE SAME

(71) Applicant: Coupang Corp., Seoul (KR)

(72) Inventors: Jeong Kwon YANG, Seoul (KR); Bo Mi CHOI, Seoul (KR)

(21) Appl. No.: 17/187,515

(22) Filed: Feb. 26, 2021

(30) Foreign Application Priority Data
Jan. 26, 2021 (KR) 10-2021-0010767

(51) Int. Cl. G06Q 20/40; G06Q 20/10; G06N 5/00

(52) U.S. Cl. CPC G06Q 20/405; G06Q 20/10; G06Q 20/407; G06Q 20/326; G06Q 20/4012; G06Q 20/40145; G06N 5/003; G06Q 20/4016

(57) ABSTRACT

Provided is a method of providing a payment service according to various example embodiments. The method of providing a payment service may include acquiring a payment request for an item from a user, identifying whether the acquired payment request satisfies designated conditions, and omitting an additional authentication operation in response to the payment request satisfying the designated conditions and providing payment completion information corresponding to the payment request. Other example embodiments are possible.

### BACKGROUND

### Technical Field

The present disclosure relates to a method of providing a payment service and an electronic apparatus performing the same.

### Description of the Related Art

With the development of electronic apparatuses, various types of portable terminals with various functions are being widely popularized. In addition, with the recent activation of e-commerce, online orders and payments using terminals are increasingly being performed.

Unlike existing offline transactions, in such online payments, user information may be stolen by others and fraudulent transactions may be made. Therefore, online payments may require enhanced security to authenticate users themselves, and as a result, various and complex user authentication methods have been applied.

However, such complex authentication methods may be a barrier to online payments and cause more hassle and inconvenience to users rather than anxiety about security. As a result, there is a trend to make a compromise between security and convenience.

### SUMMARY

### Technical Goals

An aspect provides a method of providing a payment service with improved security and convenience, and an electronic apparatus performing the same.

### Technical Solutions

According to an aspect, there is provided a method of providing a payment service by an electronic apparatus, including: acquiring a payment request for an item from a user; identifying whether the acquired payment request satisfies designated conditions; and omitting an additional authentication operation in response to the payment request satisfying the designated conditions and providing payment completion information corresponding to the payment request.

The method of providing a payment service may further include: transmitting a delivery request of the item in response to the providing of the payment completion information; and performing a transaction procedure in response to the payment request when a predetermined time has elapsed after the providing of the payment completion information.

The method of providing a payment service may further include: canceling the performing of the transaction procedure when a cancellation request corresponding to the payment is received within the predetermined time; and transmitting a delivery cancellation request of the item in response to the reception of the cancellation request.

The providing of the payment completion information may include providing a user interface allowing cancellation of the payment on at least some of content of the payment completion information for a set time.

The designated conditions may include a type condition of a payment means corresponding to the payment request.

The designated conditions may be determined based on the payment request. For example, the designated condition may include decision trees mapped to each type of the payment means.

The method of providing a payment service may further include requesting a predetermined additional authentication in response to the payment request not satisfying at least some of the designated conditions.

The designated conditions may include at least one of an amount limit condition corresponding to the payment request and a risk determination condition of the payment.

The risk determination condition may include a condition for at least one of type information on or regarding the item, information on a delivery destination corresponding to the payment request, and information on or regarding an apparatus that transmits the payment request.

The requesting of the predetermined additional authentication may include requesting a payment authentication using a personal identification number (PIN) or bio-information.

According to another aspect, there is provided an electronic apparatus including: a database; and a processor electrically connected to the database.

The processor may acquire a payment request for an item from a user. The processor may identify whether the acquired payment request satisfies designated conditions. The processor may determine a payment authentication method in response to the payment request satisfying the designated conditions. The processor may provide payment-authentication-related information according to the determined authentication method.

In connection with the provision of the authentication-related information, the processor may provide notification information on an authentication completion of the payment, provide notification information on an additional authentication request of the payment, or provide notification information on an authentication failure of the payment.

The processor may limit at least some of the payment authentication methods based on a user setting, and provide information related to a change in the user setting based on whether the payment-related information satisfies the designated conditions.

According to still another aspect, there is provided an application stored in a computer-readable storage medium that executes a method of providing a payment service.

The method of providing a payment service may include: receiving payment request input; determining a payment authentication method based on whether payment-related information corresponding to the payment request input satisfies designated conditions; and performing an authentication on the payment according to the determined payment authentication method.

According to yet another aspect, there is provided a computer-readable non-transitory recording medium on which a program allowing a computer to execute a method of providing a payment service is recorded.

The method of providing a payment service may include: acquiring a payment request for an item from a user; identifying whether the acquired payment request satisfies designated conditions; and omitting an additional authentication operation in response to the payment request satisfying the designated conditions and providing payment completion information corresponding to the payment request.

### Effects

According to various embodiments, it is possible to provide the convenient and quick purchase and payment functions in the safe and trusted environment by allowing the user to use the one-touch payment with improved security.

According to various embodiments, it is possible to minimize the possibility of a buyer canceling the payment and exiting the payment window during the time for the payment authentication by allowing the buyer to actively use the easy and quick one-touch payment or simple payment.

According to various embodiments, it is possible to accurately determine the risk of each payment in response to the payment means selected by the user by using the decision trees provided for each type of the payment means. As a result, the payment method with improved security and user convenience can be provided.

### BRIEF DESCRIPTION OF THE DRAWINGS

FIG. 1 is a schematic block configuration diagram of a system for providing a payment service according to various example embodiments of the present disclosure.

FIG. 2 is a schematic block configuration diagram of an electronic apparatus according to an example embodiment of the present disclosure.

FIG. 3 is a flowchart illustrating a method of providing a payment service according to an example embodiment of the present disclosure.

FIG. 4A is a flowchart illustrating a method of providing a payment service according to an example embodiment of the present disclosure.

FIG. 4B is a flowchart illustrating the method of providing a payment service according to the example embodiment of the present disclosure.

FIG. 5 is a flowchart illustrating the method of providing a payment service according to the example embodiment of the present disclosure.

FIG. 6 is a flowchart illustrating the method of providing a payment service according to the example embodiment of the present disclosure.

FIG. 7 is a flowchart illustrating the method of providing a payment service according to the example embodiment of the present disclosure.

FIG. 8 is a diagram schematically illustrating a user interface related to providing a payment service according to an example embodiment of the present disclosure.

FIG. 9 is a diagram schematically illustrating the user interface related to providing the payment service according to the example embodiment of the present disclosure.

FIG. 10 is a diagram schematically illustrating the user interface related to providing the payment service according to the example embodiment of the present disclosure.

FIG. 11 is a diagram schematically illustrating the user interface related to providing the payment service according to the example embodiment of the present disclosure.

FIG. 12 is a diagram schematically illustrating the user interface related to providing the payment service according to the example embodiment of the present disclosure.

FIG. 13 is a diagram schematically illustrating the user interface related to providing the payment service according to the example embodiment of the present disclosure.

FIG. 14 is a diagram schematically illustrating the user interface related to providing the payment service according to the example embodiment of the present disclosure.

FIG. 15 is a diagram schematically illustrating the user interface related to providing the payment service according to the example embodiment of the present disclosure.

FIG. 16 is a flowchart illustrating the method of providing a payment service according to the example embodiment of the present disclosure.

### DETAILED DESCRIPTION

General terms that are currently widely used are selected as terms used in example embodiments in consideration of functions in the present disclosure but may be changed depending on the intention of those skilled in the art or a judicial precedent, the emergence of a new technique, and the like. In addition, in specific cases, there may be terms arbitrarily chosen by the applicant. In this case, the meaning of such a term will be described in detail in a corresponding description portion. Therefore, the terms used in the present disclosure should be defined on the basis of the meanings of the terms and the content throughout the present disclosure rather than the simple names of the terms.

Throughout the specification, unless otherwise designated, “including” any component means that other components may be further included rather than excluding other components. In addition, the terms “unit,” “module,” and the like described in the specification refer to a processing unit of at least one function or operation and may be implemented by hardware or software or a combination of hardware and software.

The expression “at least one of a, b, and c” described throughout the specification may include “a alone,” “b alone,” “c alone,” “a and b,” “a and c,” “b and c,” or “all of a, b, and c.”

A “terminal” described below may be implemented as a computer or a portable terminal that may access a server or other terminals through a network. Here, computers may include, for example, a notebook computer, a desktop computer, a laptop computer, and the like, which are equipped with a web browser, and portable terminals are wireless communication devices that ensure portability and mobility, and may include, for example, all kinds of handheld-based wireless communication devices such as a communication terminal, a smartphone, and a tablet personal computer (PC) which support International Mobile Telecommunications (IMT), code division multiple access (CDMA), W-code division multiple access (W-CDMA), Long Term Evolution (LTE) terminals, etc.

Hereinafter, example embodiments of the present disclosure will be described in detail with reference to the accompanying drawings so that those skilled in the art to which the present disclosure pertains may easily practice the present disclosure. However, the present disclosure may be implemented in various different forms and is not limited to the example embodiments described herein.

Hereinafter, example embodiments of the present disclosure will be described with reference to the accompanying drawings.

In describing the example embodiments, descriptions of technical contents that are well known in the technical field to which the present disclosure pertains and are not directly related to the present disclosure will be omitted. This is to more clearly convey the gist of the present disclosure without ambiguity by omitting unnecessary explanations.

For the same reason, some components in the accompanying drawings are exaggerated, omitted, or schematically illustrated. In addition, the size of each component does not entirely reflect the actual size. The same reference numerals are assigned to the same or corresponding components in each drawing.

Various advantages and features of the present disclosure and methods of accomplishing them will become apparent from the following description of example embodiments with reference to the accompanying drawings. However, the present disclosure is not limited to the example embodiments disclosed herein but will be implemented in various forms. The example embodiments make contents of the present disclosure thorough and are provided so that those skilled in the art can easily understand the scope of the present disclosure. Therefore, the present disclosure will be defined by the scope of the appended claims. Throughout the specification, like reference numerals denote like components.

In this case, it will be appreciated that each block of a processing flowchart and combinations of the flowcharts may be executed by computer program instructions. Since these computer program instructions may be mounted in a processor of a general computer, a special computer, or other programmable data processing apparatuses, these computer program instructions executed through the process of the computer or the other programmable data processing apparatuses create means performing functions described in the block(s) of the flowcharts. Since these computer program instructions may also be stored in a computer usable or computer readable memory of a computer or other programmable data processing apparatuses in order to implement the functions in a specific scheme, the computer program instructions stored in the computer usable or computer readable memory can also produce manufacturing articles including instruction means performing the functions described in the block(s) of the flowcharts. Since the computer program instructions may also be mounted on the computer or the other programmable data processing apparatuses, the instructions for performing a series of operation steps on the computer or the other programmable data processing apparatuses to create processes executed by the computer, thereby executing the computer or the other programmable data processing apparatuses may also provide operations for performing the functions described in the block(s) of the flowchart.

In addition, each block may indicate some of modules, segments, or codes including one or more executable instructions for executing a specific logical function(s). Further, it is to be noted that functions mentioned in the blocks occur regardless of a sequence in some alternative example embodiments. For example, two blocks that are consecutively shown can in fact be simultaneously performed or can be performed in a reverse sequence depending on corresponding functions.

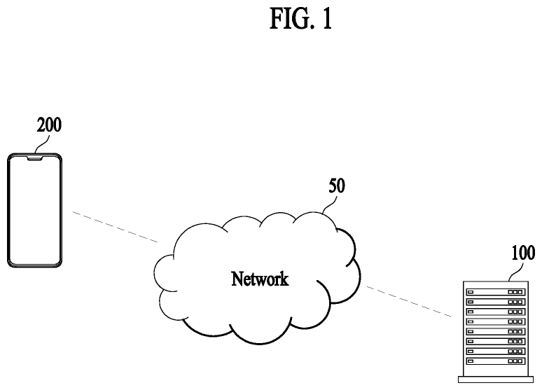

FIG. 1 is a schematic block configuration diagram of a system for providing a payment service according to various example embodiments of the present disclosure.

According to various example embodiments, a payment authentication system may include an electronic apparatus 100 (for example, a server), a user terminal 200, and a network 50.

The electronic apparatus 100 is an apparatus that performs various types of processing to provide a payment service and may perform various functions related to payment according to a payment request input received from at least one user terminal 200 through the network 50.

The electronic apparatus 100 may include a plurality of computer systems or computer software implemented as a network server. The electronic apparatus 100 may provide a variety of information organized into web pages.

For example, the electronic apparatus 100 may be referred to as the computer system and the computer software that are connected to a lower device capable of communicating with other network servers through a computer network such as an intranet or the Internet to accept a working execution request, perform an operation thereon, and provide an execution result. In addition, the electronic apparatus 100 may be understood as a broad concept including a series of application programs that may operate on a network server and various databases built therein. For example, the electronic apparatus 100 may be implemented using network server programs that are variously provided according to operating systems such as DOS, Windows, Linux, UNIX, or MacOS.

The network 50 may serve to connect the electronic apparatus 100 and the user terminal 200 or connect the electronic apparatus 100 and an external device (not illustrated). For example, the network 50 may provide an access path so that the user terminal 200 is connected to the electronic apparatus 100 to transmit and receive packet data.

Operations of a system for providing a payment service according to an example embodiment of the present disclosure may be implemented through the electronic apparatus 100, and the user terminal 200 may be connected to the payment system through the network 50.

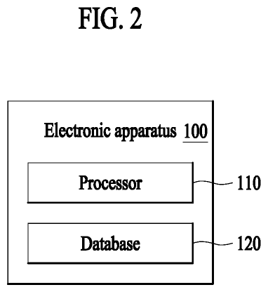

The electronic apparatus 100 may store information received from the user terminal 200 in a database (for example, a database 120 of FIG. 2) or transmit information stored in the database to the user terminal 200.

According to another example embodiment, at least some functions of the system for providing a payment service may be implemented through the user terminal 200. For example, a user may install and use an application-type system for providing a payment service on the user terminal 200 through the network 50.

The system for providing a payment service according to various example embodiments may be implemented as a single physical device or may be implemented in a manner in which a plurality of physical devices are organically coupled. For example, some of the functions provided by the electronic apparatus 100 may be implemented by any one physical device, and the rest of the functions may be implemented by other physical devices. For example, any one physical device may be implemented as a part of the electronic apparatus 100, and other physical devices may be implemented as a part of the user terminal 200 or a part of an external device (not illustrated). In some cases, the components included in the system for providing a payment service may be distributed and arranged in different physical devices, and the distributed and arranged components may be organically coupled to perform the functions and operations of the system for providing a payment service.

FIG. 2 is a schematic block configuration diagram of an electronic apparatus according to an example embodiment of the present disclosure.

Referring to FIG. 2, the electronic apparatus 100 (for example, a server) according to various example embodiments may include at least one of a processor 110 and a database 120.

The processor 110 may process a series of functions for performing a method of providing a payment service according to various example embodiments of the present disclosure and may generally control operations of other component(s) of the electronic apparatus 100.

For example, the processor 110 may determine a payment authentication method of an order for which payment is requested based on at least some of user setting information, payment amount limit condition information, and payment risk determination condition information that are related to a payment authentication method.

For example, the processor 110 may perform payment authentication according to the determined payment authentication method and may provide authentication-related information on payment.

For example, the processor 110 may determine a payment authentication method based on a payment risk determination condition that is determined based on a type of payment means designated by the user.

For example, the processor 110 may determine a payment authentication method of each payment, including, as the payment risk determination condition, conditions for at least some of type information of a payment target item, delivery destination information of the payment target item, location information of a user and/or apparatus corresponding to a payment request, or payment history information.

In addition, the processor 110 may implement various functions related to providing a payment service according to various example embodiments of the present disclosure to be described below.

The database 120 has a data structure implemented in a predetermined storage space of the electronic apparatus 100, and thus functions such as storing, searching, deleting, editing, or adding data may be freely performed. For example, the database 120 may include fields or elements for processing functions such as storing, searching, deleting, editing, or adding data.

The database 120 may store data related to various functions of the electronic apparatus 100. For example, the database 120 may store various types of information (for example, decision tree information or the like corresponding to a type of payment means) related to a method of providing a payment service and may store instructions for an execution operation of the processor 110 or data.

Meanwhile, although not illustrated, the electronic apparatus 100 may further include a communication module. For example, the communication module may perform a function of transmitting information stored in the database 120 of the electronic apparatus 100 or predetermined information processed by the processor 110 to other devices or allowing the electronic apparatus 100 to receive information from the other devices. For example, the communication module may receive predetermined user input information (for example, a payment request input or the like) from the user terminal 200 of FIG. 1. For example, the communication module may include a transceiver for transmitting and receiving information.

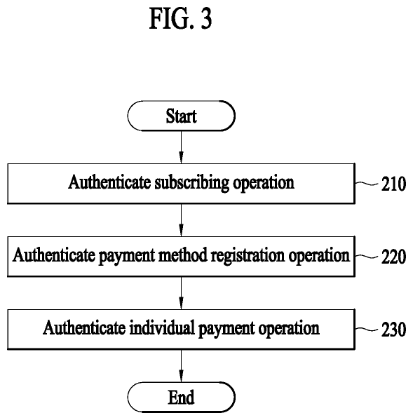

FIG. 3 is a flowchart illustrating the method of providing a payment service by an electronic apparatus according to various example embodiments of the present disclosure.

Referring to FIG. 3, the electronic apparatus 100 may perform user authentication related to provision of a payment service through a payment-related application or program installed in the user terminal 200.

For example, in operation 210, the electronic apparatus 100 may first perform user authentication in an initial subscription operation for using a payment service. Meanwhile, when a user wants to log in to the payment service through an application or program installed in the user terminal 200, the electronic apparatus 100 may perform authentication in response to user identification information registered in the subscription operation.

Next, in operation 220, the electronic apparatus 100 may perform a predetermined authentication in an operation of registering a payment means (e.g., payment method).

For example, a user may register a payment means he/she wishes to use for payment in a payment service. For example, the payment means may include at least one of credit card or check card registration, bank account registration, and user terminal registration for using a simple payment service. The electronic apparatus 100 may perform user authentication in the operation of registering the payment means and store information related thereto.

Next, in operation 230, the electronic apparatus 100 may perform authentication in an operation of performing individual payment.

In various example embodiments, when a user determines to purchase a specific item or service, he/she may request payment for the specific item or service from the electronic apparatus 100. The electronic apparatus 100 may perform authentication for each payment request case based on at least some pieces of predetermined information (for example, user identification information, user login information, and the like) acquired during the subscription operation authentication 210, predetermined information (for example, card information, bank account information, user terminal information, and the like) acquired during the payment means registration operation authentication 220, and individual case information requested for payment (for example, type information of a payment target item, delivery destination information, payment amount information, and the like).

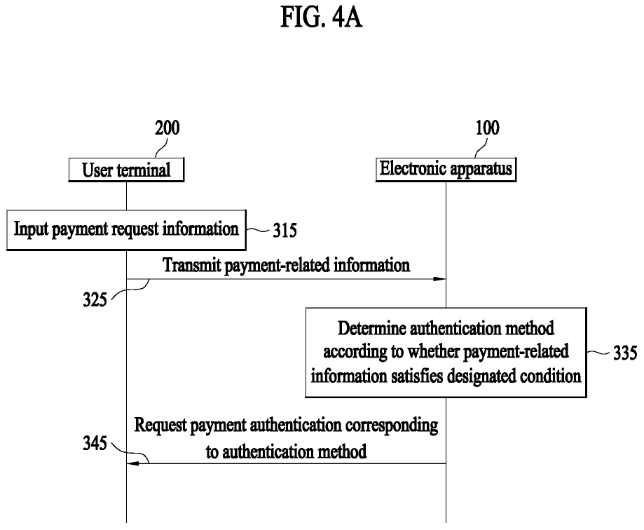

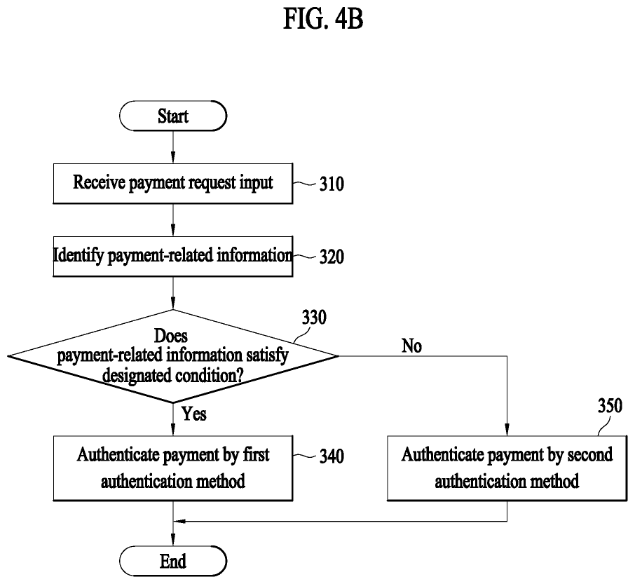

FIGS. 4A and 4B are flowcharts illustrating the method of providing a payment service according to the example embodiment of the present disclosure. For example, FIGS. 4A and 4B may correspond to the drawings for specifically explaining operation 230 of FIG. 3 described above.

Referring to FIGS. 4A and 4B, the electronic apparatus 100 according to various example embodiments may receive a specific payment request input from the user terminal 200 in operation 310.

For example, in operation 315, a user may request payment for one or more purchased items using a payment-service-related application or program installed in the user terminal 200. For example, a user may perform payment using a different payment means for each payment request case and may request delivery of the purchased item to a different delivery destination upon payment, and therefore different payment-related information may be transmitted to the electronic apparatus 100 in response to each payment request in operation 325.

In operation 320, the electronic apparatus 100 may identify information related to the requested payment. Here, the payment-related information may include at least some pieces of user identification information, user login information, a user's payment authentication history information, payment means information, payment item information, and delivery destination information.

Next, the electronic apparatus 100 may determine whether the payment-related information satisfies designated conditions in operations 330 and 335.

For example, when it is determined that the payment-related information satisfies the designated conditions, the electronic apparatus 100 may perform payment authentication using a first authentication method in operation 340. In addition, when it is determined that the payment-related information does not satisfy at least some of the designated conditions, the electronic apparatus 100 may perform payment authentication using a second authentication method in operation 350. As described above, the electronic apparatus 100 may determine the payment authentication method differently based on whether the payment-related information satisfies the designated conditions.

For example, the designated conditions may include at least some of an amount limit condition corresponding to a payment request, a type condition of an item to be paid, a condition for a delivery destination of an item, and a condition for an apparatus or a user (user account) for which payment is requested. For example, the electronic apparatus 100 may determine a payment authentication method by identifying whether all of the above-described conditions are satisfied in operation 335, and determine a payment authentication method by identifying whether or not some of the above-described conditions are satisfied according to a set condition.

For example, the first authentication method may correspond to one-touch payment in which the payment authentication is immediately completed in response to the satisfaction of the designated conditions. For example, when the payment authentication method is determined as the first authentication method, the electronic apparatus 100 may complete the payment authentication in response to the satisfaction of the designated conditions and may not request an additional authentication procedure.

For example, the second authentication method may correspond to an authentication method requiring a predetermined additional payment authentication procedure in response to not satisfying at least some of the designated conditions. For example, the second authentication method may correspond to simple payment in which payment authentication is performed by using a personal identification number (PIN) input or bio-information (for example, fingerprint information, iris information, facial recognition information, and the like) input even when a user does not input card information or account information.

Although not illustrated, the electronic apparatus 100 may determine to perform payment authentication using a third authentication method when the payment-related information does not satisfy a specific condition. In this case, the electronic apparatus 100 may request a user to perform payment authentication based on stricter standards, such as authorized authentication and user authentication through a terminal in the user's own name. Meanwhile, according to another example embodiment, the electronic apparatus 100 may determine to transmit a message notifying that the payment authentication has failed to the user terminal 200, instead of determining to perform the payment authentication using the third authentication method.

Meanwhile, in the example embodiment, when the payment is made by the first authentication method that does not require additional authentication, a user interface (UI) for immediately canceling payment on a payment completion page may be provided to a user. Through this, it is possible to improve the user experience by allowing the user to immediately cancel the payment even when the payment is completed due to incorrect input.

In addition, in the example embodiment, when the payment is made by the first authentication method, a transaction for actual payment may be performed after waiting a predetermined time. Accordingly, when a user provides the payment cancellation input within the predetermined time, a procedure of returning after the actual transaction occurs may be omitted by canceling the execution of the transaction from the waiting transaction list. However, even when the transaction is not performed, the request for the paid item may be transmitted to a delivery-related server in response to the payment procedure. Accordingly, the delivery may be completed more quickly, and in the case of the delivery, even when the transaction is canceled before the delivery, the cost of cancellation is relatively low, and because it takes a certain time for the product to be located, when the cancellation occurs within the predetermined waiting time, the locating of the product may be canceled at the same time. Meanwhile, in the example embodiment, the transaction may include requesting a user to pay a payment amount through the payment means used for payment, and receiving a response corresponding thereto. For example, in the case of payment using a specific account, the transaction may include requesting a server of a business operator managing the account to pay a payment amount. Through such a transaction and delivery request method, additional costs due to the transaction cancellation may be reduced, and by making a delivery request in response to the provision of the payment completion information, a user may have time to receive a payment item based on the time when he/she is provided with the payment completion information. More specifically, in the service provided by the electronic apparatus, a time period during which the item may be delivered may be determined based on the time at which the user paid for the item. In the case of performing payment using the first authentication method in the example embodiment of the specification, the actual transaction according to the payment may be made when a predetermined time has elapsed after the payment completion information is provided, but the delivery request may be executed immediately, and thus the time required for delivery may be secured, and items may be provided within the delivery completion time when the item information is provided to a user.

However, the present disclosure is not limited to the above-described example embodiment, and according to another example embodiment of the present disclosure, when the electronic apparatus 100 repeatedly receives a payment request with the same content more than twice within a set time, the payment process is performed based on a first received payment request case(s), and subsequent payment request(s) are automatically ignored, so that duplicate payment may be prevented. Alternatively, the electronic apparatus 100 may prevent the duplicate payment for the subsequent payment request case(s) by transmitting a reconfirmation request notification to the user.

Meanwhile, in the example embodiment, when a payment request is made at a specific time, even when other conditions satisfy the conditions of using the first authentication method, the payment may be made by the second authentication method. More specifically, abuse may be prevented by setting a time period in which abuse frequently occurs with a specific payment method, and preventing payment using the first authentication method during that time period.

In operation 345, the electronic apparatus 100 may request payment authentication from the user terminal 200 in response to the determined authentication method (for example, a second authentication method or a third authentication method). As another example, the electronic apparatus 100 may transmit a payment completion guide or payment failure (or approval rejection) guide message to the user terminal 200.

Meanwhile, in the example embodiment, the electronic apparatus 100 may manage blacklist information among users in connection with each authentication method. Such blacklist information may be created based on the existing usage history of each user in a service operated by the electronic apparatus 100. When a user included in such a blacklist requests payment, the electronic apparatus 100 may provide a payment rejection message without determining whether payment information satisfies designated conditions.

In addition, in the example embodiment, the electronic apparatus 100 may determine an authentication method based on delivery information related to an item purchased by a user. According to an example, when a user requests delivery to a delivery destination to which delivery has previously been performed a certain number of times or more, the electronic apparatus 100 may perform payment authentication using the first authentication method, and may perform the payment authentication by the second authentication method when the delivery destination is changed in a delivery request.

In addition, in the example embodiment, the electronic apparatus 100 may set a standard for determining an authentication method differently based on at least one of the type information of the payment means and the payment amount. More specifically, when the risk of theft is high or damage is expected in the event of theft, the authentication method may be determined by applying a more stringent standard.

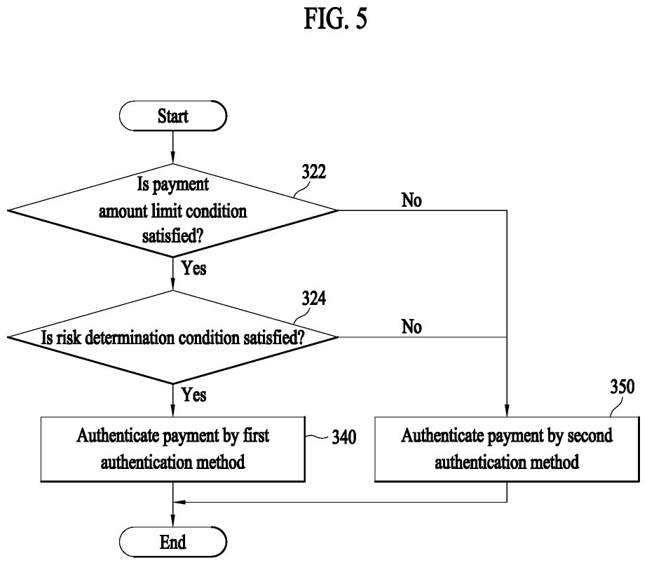

FIG. 5 is a flowchart illustrating the method of providing a payment service by the electronic apparatus according to the example embodiment of the present disclosure.

Referring to FIG. 5, the electronic apparatus 100 according to the example embodiment may first determine whether the payment amount of the payment target item (or service) included in the requested payment-related information exceeds a preset threshold amount in response to the payment request input acquired from the user terminal 200 in operation 322.

For example, in operation 322, when the payment amount is less than or equal to a preset amount, the process may move to operation 324 to perform an operation of identifying whether the risk determination condition is satisfied, and when the payment amount exceeds the preset amount, the process may move to operation 350 to determine the payment authentication method of a corresponding payment case using the second authentication method (for example, a simple payment authentication method by inputting a PIN or the like).

According to some example embodiments, prior to performing operation 322, the electronic apparatus 100 may first confirm whether the user is allowed to use the simple payment (and one-touch payment) and may perform operations after operation 322 as long as the user is allowed to use the simple payment. On the other hand, according to another example embodiment, the electronic apparatus 100 may perform operations after operation 322 even when the user is not allowed to use the simple payment, and as a result, may confirm whether the corresponding payment corresponds to a payment for which payment authentication is possible using the first authentication method.

In operation 324, the electronic apparatus 100 may identify whether the payment-related information satisfies the designated risk determination condition.

For example, the electronic apparatus 100 may include a decision tree related to the risk determination condition and determine a payment authentication method based on the decision tree. As another example, the electronic apparatus 100 may replace the decision tree or determine a payment authentication method based on a machine-learning-based learning model in addition to the decision tree.

According to the example embodiment, the risk determination condition may at least include a condition for the type information of the payment target item. For example, when the purchased item for which payment is requested is a gold-related product with good currency or a digital item related to data, the electronic apparatus 100 may determine the payment to be a payment with a relatively high risk and may determine to apply a payment authentication method with enhanced security.

According to another example embodiment, the risk determination condition may at least include a condition for delivery destination information of a payment target item. For example, when a delivery destination of a specific item for which payment is requested by a specific user is different from a delivery destination of a previously paid purchase case, the electronic apparatus 100 may determine that the payment is a payment with a relatively high risk and may request authentication by a payment authentication method with more enhanced security when a location of a terminal to which a user's payment request is transmitted and a delivery destination location exceed the designated distance range or are in different countries.

According to another example embodiment, the risk determination condition may include at least a condition for an apparatus (for example, the user terminal 200) on which a payment request is performed. For example, the condition may include a condition for at least one of the payment history and the location information corresponding to the apparatus to which the payment request is input. For example, the electronic apparatus 100 may determine a payment as a payment with a relatively high risk and request authentication by a payment authentication method with enhanced security based on the existing history information for which the payment is completed on the apparatus where the payment request is input, when payment has not recently been performed for a predetermined period, when multiple payment attempts occur on the corresponding apparatus during a designated time, when a payment request is made from an apparatus with no previous login history, when it is estimated that the payment request is input overseas based on Internet protocol (IP) information of the apparatus through which the payment request is input, and the like.

According to another example, the risk determination condition may include determining a payment as a payment with a relatively high risk and requesting authentication by a payment authentication method with enhanced security based on the identification information of the user who inputs the payment request, when the number of times or frequency of failures of the existing payment of the user is greater than or equal to a threshold value, when an accumulated amount of an item for which payment is requested within a designated time exceeds the set value, when the number of times or frequency of changes of a password related to a user's login authentication or a password related to authentication for individual payment cases is greater than or equal to the threshold value, and the like.

In this way, the electronic apparatus 100 may determine the payment authentication method based on whether the payment-related information satisfies the risk determination condition and may complete authentication, request authentication related to the simple payment, request detailed identity authentication, or provide authentication failure guidance according to whether the risk determination condition is satisfied.

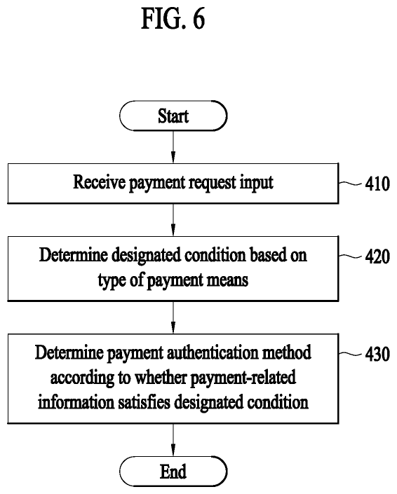

FIG. 6 is a flowchart illustrating the method of providing a payment service by the electronic apparatus according to the example embodiment of the present disclosure.

Referring to FIG. 6, the electronic apparatus 100 according to the example embodiment may receive a payment request input from a user in operation 410 and may determine designated conditions based on selection information on a type of payment means of a user included in the payment-related information based on the payment-related information corresponding to the payment request input in operation 420.

For example, the electronic apparatus 100 may include one or more decision trees in the database 120. The decision trees may be set differently for each type of the payment means and may be determined according to the type of payment means input by the user. For example, a user may select a type of payment means related to whether to pay by a card, whether to pay by transfer through a bank account, whether to pay from a pre-deposited reserve balance, or the like. When the user selects the type of payment means as a card payment type, the electronic apparatus 100 may determine a first condition (for example, a first decision tree) corresponding to the card payment as the above-described designated condition. In addition, when the user selects the type of payment means as the bank account transfer type, the electronic apparatus 100 may determine a second condition (for example, a second decision tree) corresponding to the bank account transfer as the designated condition. In addition, when the user selects the type of payment means as the reserve balance type, the electronic apparatus 100 may determine a third condition (for example, a third decision tree) corresponding to the reserve balance as the designated condition. The first to third conditions may differ from each other in at least some detailed conditions (for example, an item of detailed conditions, a determination order of each detailed condition, and/or threshold information of each detailed condition).

In operation 430, the electronic apparatus 100 may determine whether the payment-related information corresponding to the payment request input in operation 410 satisfies the condition determined based on the type of payment means in operation 420 and determine the payment authentication method according to whether or not it does.

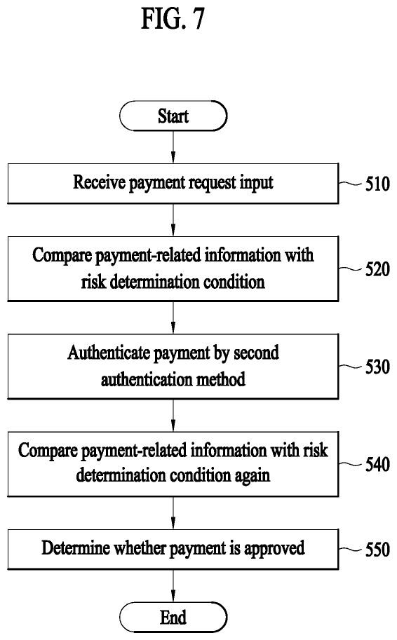

FIG. 7 is a flowchart illustrating the method of providing a payment service according to the example embodiment of the present disclosure.

Referring to FIG. 7, according to the example embodiment, the electronic apparatus 100 may receive a payment request input in operation 510, and compare the payment-related information corresponding to the payment request input with a preset condition (for example, the risk determination condition) in operation 520 to determine at least one of the payment authentication method and the payment authentication according to the degree of risk. According to various example embodiments, the electronic apparatus 100 may perform an operation in operation 520 as long as the conditions related to the payment amount limit are satisfied and/or the user's simple payment (and one-touch payment) designation is satisfied.

In operation 530, the electronic apparatus 100 may determine the payment authentication method of the corresponding payment corresponding to the payment request input as the second authentication method based on the risk determination condition and transmit the request to perform the payment authentication of the second authentication method to the user terminal 200. As a result, the user may perform the payment authentication using the second authentication method. For example, the user may authenticate payment through a second authentication method through the PIN or bio-information input.

On the other hand, the electronic apparatus 100 according to the embodiment may compare the risk determination condition again based on the payment-related information related to the authentication using the second authentication method in operation 540 when the payment authentication using the second authentication method by the user is completed.

For example, even when the electronic apparatus 100 succeeds in the authentication by the second authentication method in operation 530, the electronic apparatus 100 may again compare the risk determination condition based on the number (or frequency) of times of authentication failures or the like during the user authentication by the second authentication method in operation 540 and finally determine whether to approve the payment in operation 550.

For example, even when the user succeeds in the authentication by the second authentication method, the electronic apparatus 100 may not finally approve the payment authentication based on the risk determination condition comparison in operation 550. In this case, the electronic apparatus 100 may request that the user terminal 200 requests the authentication again using a more enhanced security authentication method or transmits a guide message related to payment approval rejection (or failure) and terminates the payment function.

Meanwhile, in the example embodiment, it may be determined whether the payment-related information satisfies the risk determination condition based on at least one of, as the payment-related information, account information of a user who requests payment, information on or regarding an item to be paid for, information on or regarding a terminal that transmits a payment request, and information on the time when the payment request occurs. In addition, according to the example embodiment, the priority of information that is the determination criterion may be set differently.

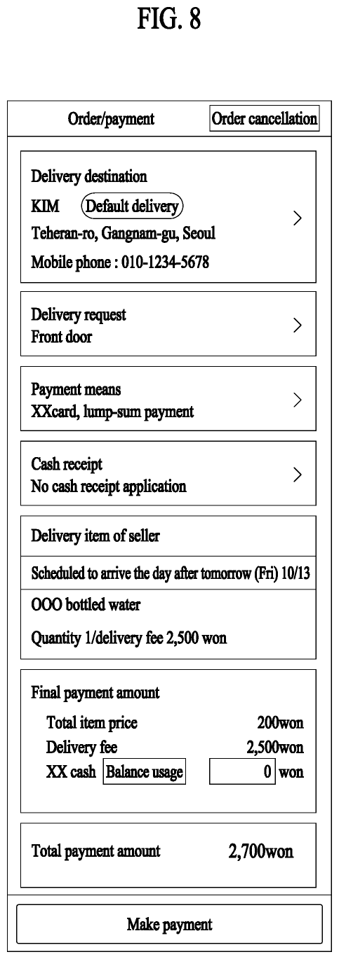

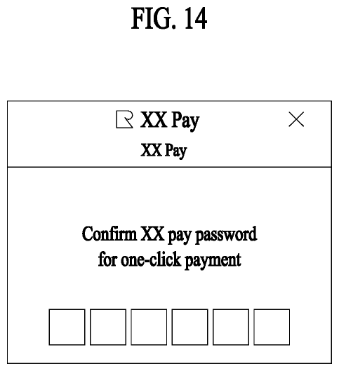

FIGS. 8 to 15 are diagrams schematically illustrating the UI related to providing the payment service according to various example embodiments of the present disclosure.

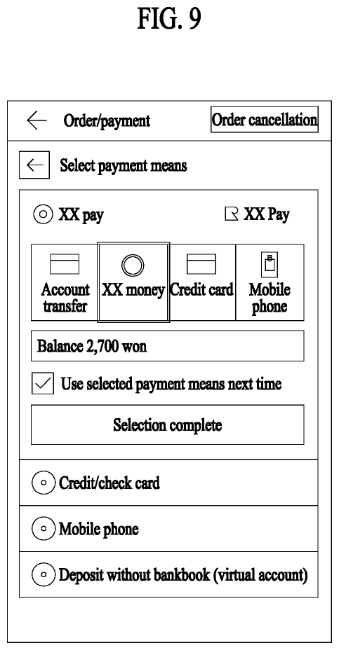

Referring to FIG. 8, the electronic apparatus 100 according to the example embodiment may provide an interface screen through which a user terminal 200 may order and pay for a specific item. The user may input information on a delivery destination to which a payment target item is delivered and contact information and confirm a payment amount and provide payment request information to the electronic apparatus 100 by pressing a payment request button (for example, a “payment” button). Meanwhile, the user may set the payment means or change the preset payment means in connection with the payment, and a more specific UI screen is illustrated in FIG. 9 in connection therewith.

As illustrated in FIG. 9, the user may select the type of payment means in connection with whether to perform payment by the bank transfer method, whether to perform payment using the reserve balance, whether to perform payment using a credit card (or a check card) payment method, whether to perform payment by a payment method through the user terminal (for example, a mobile phone), or the like.

For example, the electronic apparatus 100 may encrypt the payment-related information (for example, account information, card information, and the like) acquired by registering a payment means in connection with a simple payment service (for example, XX Pay) and store the encrypted payment-related information in the database 120, perform one-touch payment authentication (for example, PIN non-input authentication) as the first authentication method when the payment is determined to be a payment with a low risk according to a result of determining the risk for individual payment cases, or determine and process the payment authentication method using the simple payment method (for example, PIN input authentication) as the second authentication method when the payment is determined to be payment with a slightly low risk.

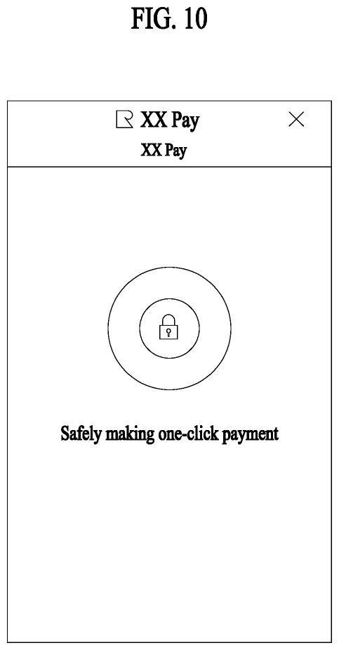

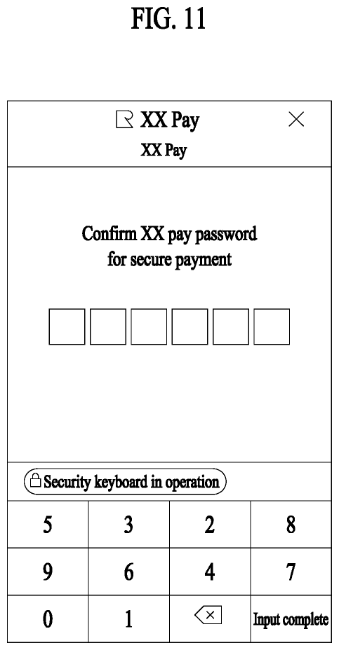

For example, when the user inputs the payment request by clicking the payment button on the screen of FIG. 8, the electronic apparatus 100 may identify whether it is possible to perform the one-touch payment or the simple payment based on whether the designated conditions are satisfied based on the information on the payment, may provide the interface screen of FIG. 10 through the user terminal 200 when the one-touch payment is allowed, and may provide the interface screen as illustrated in FIG. 11 when the simple payment is allowed.

For example, when payment is completed without an additional payment authentication procedure as in the case where the one-touch payment is allowed, there is a possibility of a user repeatedly inputting a payment request (for example, through a payment button) as the user may not confirm whether the payment is approved while determining whether to approve the one-touch payment, and thus a duplicate order for the same item and a duplicate payment problem may occur, and therefore the electronic apparatus 100 may minimize errors in repetitive payment attempts from the user by providing a guide interface related to the payment procedure as illustrated in FIG. 10.

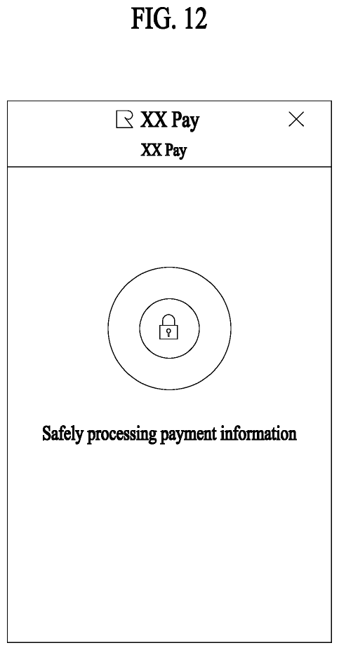

On the other hand, as in the example embodiment in which the simple payment is allowed, the electronic apparatus 100 may provide an interface to guide the payment authentication through the PIN input as illustrated in FIG. 11. In addition, when the user inputs the PIN, a screen is switched to the interface screen illustrated in FIG. 12 to provide screen information related to the payment information processing procedure.

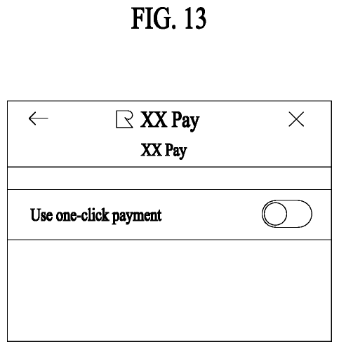

Referring to FIGS. 13 to 15, the electronic apparatus 100 according to the example embodiment may provide a related interface screen so that a user may designate whether to use a one-touch (or one-click) payment method.

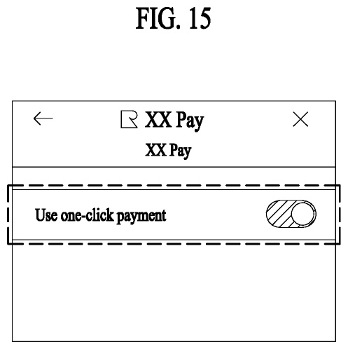

For example, as illustrated in FIG. 13, the use of the one-touch payment method may be restricted so that the user does not use the one-touch payment method, and when the restrictions on the use of the one-touch payment method are released so that the user may use the one-touch payment method again as illustrated in FIG. 15, the electronic apparatus 100 may be set to allow the use of the one-touch payment through a predetermined authentication procedure (for example, the authentication of the PIN input related to the simple payment service).

According to the example embodiment of the present disclosure, when the user does not allow the use of the one-touch payment, the electronic apparatus 100 may also provide notification information suggesting the use of the one-touch payment in an operation of providing a payment approval completion notification as the user orders and pays for a specific item and goes through a predetermined payment authentication procedure. For example, the electronic apparatus 100 may compare information related to the user's payment case with the designated conditions (for example, a payment amount limit condition and/or a payment risk determination condition), and provide the notification information suggesting the use of the one-touch payment as long as it is determined that the payment meets the conditions under which the one-touch payment is allowable.

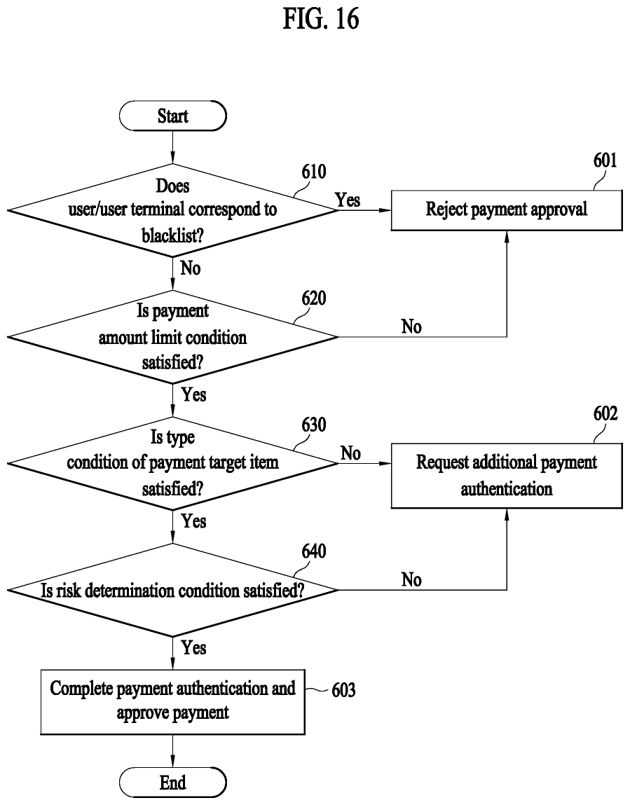

FIG. 16 is a flowchart illustrating the method of providing a payment service according to the example embodiment of the present disclosure.

Referring to FIG. 16, the electronic apparatus 100 according to the example embodiment may first determine whether a user and/or a user terminal corresponding to a specific payment request input in operation 610 corresponds to a target listed on the blacklist. The blacklist information may be previously stored in the database 120 of the electronic apparatus 100 and may be updated in the database 120 whenever a problem related to payment authentication occurs. For example, the electronic apparatus 100 may identify whether the corresponding user and/or the user terminal corresponds to a blacklist based on a user's login history, an IP address of an accessed terminal, or the like.

When it is determined that the user or the user terminal corresponding to the payment request input corresponds to the blacklist target, the electronic apparatus 100 may reject the payment approval for the payment request in operation 601 and provide the notification information related thereto.

On the other hand, when it is determined that the user or the user terminal corresponds to a payment request not related to the blacklist, in operation 620, the electronic apparatus 100 may determine whether the corresponding payment target satisfies a preset amount limit condition.

For example, when the amount requested for payment exceeds the preset amount limit, the electronic apparatus 100 may branch to operation 601 and reject approval for the corresponding payment. However, the present disclosure is not limited to the example embodiment, and in the case of the payment target case that exceeds the above amount limit, the electronic apparatus 100 may branch to operation 602 to request the additional payment authentication such as the PIN input (or, bio-information input or other personal-authentication-related password input) request and approve the payment according to the additional payment authentication result.

In addition, when the amount requested for payment is less than or equal to the preset amount limit range, the electronic apparatus 100 may determine whether the condition related to the payment target item type is satisfied in operation 630. For example, when an item for which payment is requested corresponds to a digital item (or gold-related product), the electronic apparatus 100 may request the additional payment authentication for the payment in operation 602.

For example, when the condition of operation 630 is satisfied because the item for which payment is requested does not correspond to the digital item, the electronic apparatus 100 may determine whether or not other risk determination conditions are satisfied in operation 640.

For example, the risk determination condition may include first risk conditions for detecting the case of attempting payment by stealing someone else's card or bankbook and second risk conditions for detecting a case of attempting payment by stealing user-account-related information (for example, an ID and password). In addition, the risk determination condition may further include third risk conditions for determining a risk for a payment case by a new user terminal having no previous payment history. According to the example embodiment, the electronic apparatus 100 may first determine whether the payment-related information corresponding to the payment request input satisfies the first risk conditions, then determine whether the payment-related information satisfies the second risk conditions, and then determine whether the payment-related information satisfies the third risk conditions in operation 640, and may immediately complete payment authentication and approve the payment based on the determination result in operation 603 or may request additional payment authentication in operation 602.

According to various example embodiments, the electronic apparatus 100 may include at least some of, as the risk determination condition, a condition on whether an apparatus through which payment is requested (for example: user terminal) is the same as the apparatus through which a user performs the existing payment (for example: initial payment), a condition as to whether a delivery address corresponds to a delivery address at the time of the existing payment (for example: initial payment), a condition as to whether the delivery address is domestic, a condition as to whether the user and/or user terminal corresponds to a white list, a condition for the number of times or frequency of changes of payment-authentication-related information (for example: various passwords such as a PIN) within the last N hours, a condition for the number of times or frequency of failures of payment authentication within the last N hours, a condition related to the existing payment authentication history (for example: one-touch payment success history, history of authentication through the simple payment method or the general payment method within the last N hours), a condition related to a login history from two or more user accounts on one user terminal, a condition related to the amount of payments attempted within a designated time on one device (user terminal), and a condition related to the amount/number of payment attempts within a designated time from one user account. Each of the conditions may or may not have a predetermined priority, and may have a decision tree including different conditions for each payment means.

Meanwhile, according to another example embodiment, the electronic apparatus 100 may always perform the additional payment authentication request regardless of a final risk determination result when the waiting time for identifying whether the risk determination condition is satisfied exceeds the designated threshold time, in operation of identifying whether the risk determination condition is satisfied.

Meanwhile, the example embodiment of the present disclosure has been disclosed in the present specification and drawings, and although specific terms have been used, they have merely been used in a general sense to easily describe the technical content of the present disclosure and to aid understanding of the present disclosure, and are not intended to limit the scope of the present disclosure. It is obvious to those of ordinary skill in the art to which the present disclosure pertains that other modifications based on the technical idea of the present disclosure can be implemented in addition to the example embodiments disclosed herein.

The electronic apparatus or terminal according to the above-described example embodiments may include a processor, a memory that stores and executes program data, a permanent storage such as a disk drive, a communication port that communicates with an external device, a touch panel, a key, a UI device such as a button, and the like. Methods implemented as software modules or algorithms may be stored on a computer-readable recording medium as computer-readable codes or program instructions executable on the processor. Here, examples of the computer-readable recording medium may include magnetic storage media (for example, a read-only memory (ROM), a random-access memory (RAM), a floppy disk, a hard disk, etc.), optical reading media (for example, a compact disk (CD)-ROM or a digital versatile disc (DVD)), and the like. The computer-readable recording medium may be distributed in computer systems connected to each other through a network, and as a result, the computer-readable codes may be stored and executed in a distributed scheme. The medium may be readable by a computer, stored in a memory, and executed on a processor.

The present example embodiment may be represented by functional block configurations and various processing operations. These functional blocks may be implemented by various numbers of hardware and/or software components that execute specific functions. For example, the example embodiment may employ integrated circuit configurations, such as a memory, processing, logic, and a look-up table, capable of executing various functions by control of one or more microprocessors or other control devices. Similar to executing the components in software programming or software elements, the present example embodiment can be implemented in programming or scripting languages such as python, C, C++, Java, and assembler, including various algorithms implemented by a combination of data structures, processes, routines or other programming configurations. Functional aspects may be implemented in algorithms executed on one or more processors. In addition, the present example embodiment may employ a conventional technology for electronic environment setting, signal processing, and/or data processing, and the like. Terms such as “mechanism,” “element,” “means,” and “configuration” may be used broadly and are not limited to mechanical and physical configurations. The terms may include the meaning of a series of routines of software in connection with a processor or the like.

The above-described example embodiments are merely exemplary, and other example embodiments may be implemented within the scope of the following claims.

1. A method of providing a payment service by an electronic apparatus, the method comprising:
acquiring a payment request for an item from a user;
identifying whether the acquired payment request satisfies designated conditions; and
omitting an additional authentication operation in response to the payment request satisfying the designated conditions, and providing payment completion information corresponding to the payment request.

2. The method of claim 1, further comprising:
transmitting a delivery request of the item in response to the providing of the payment completion information; and
performing a transaction procedure in response to the payment request based on a predetermined time elapsing after the providing of the payment completion information.

3. The method of claim 2, further comprising:
canceling the performing of the transaction procedure based on a cancellation request corresponding to the payment being received within the predetermined time; and
transmitting a delivery cancellation request of the item in response to the reception of the cancellation request.

4. The method of claim 1, wherein the providing of the payment completion information includes providing a user interface allowing cancellation of the payment on at least some of content of the payment completion information for a set time.

5. The method of claim 1, wherein the designated conditions include a type condition of a payment means corresponding to the payment request.

6. The method of claim 1, further comprising requesting a predetermined additional authentication in response to the payment request not satisfying at least some of the designated conditions.

7. The method of claim 1, wherein the designated conditions include at least one of an amount limit condition corresponding to the payment request or a risk determination condition of the payment.

8. The method of claim 7, wherein the risk determination condition includes a condition for at least one of type information regarding the item, information on a delivery destination corresponding to the payment request, or information regarding an apparatus that transmits the payment request.

9. The method of claim 6, wherein the requesting of the predetermined additional authentication includes requesting a payment authentication using a personal identification number (PIN) or bio-information.

10. The method of claim 5, wherein the designated conditions include decision trees mapped to each type of the payment means.

11. An electronic apparatus comprising:
a database; and
a processor electrically connected to the database,
wherein the processor is configured to:
acquire a payment request for an item from a user terminal of a user;
identify whether the acquired payment request satisfies designated conditions, the designated conditions comprising a condition on whether the user terminal corresponds to an apparatus through which the user has performed the existing payment;
select a payment authentication method from a plurality of authentication methods based on whether the payment request satisfies the designated conditions, wherein the plurality of authentication methods include a first authentication method and a second authentication method that includes an additional authentication procedure compared to the first authentication method, the additional authentication procedure configured to enhance security of the payment by receiving bio-information of the user;
instruct, in response to the second authentication method being selected, the user terminal to obtain a user input of the bio-information of the user via an interface screen of the user terminal;
provide, in response to the first authentication method being selected, payment completion information corresponding to the payment request;
transmit a delivery request of the item in response to the providing of the payment completion information; and
perform a transaction procedure in response to the payment request based on a predetermined time elapsing after the providing of the payment completion information.

12. The electronic apparatus of claim 11, wherein, in connection with the provision of the payment-authentication-related information, the processor is further configured to provide notification information on authentication completion of the payment, provide notification information on an additional authentication request of the payment, or provide notification information on authentication failure of the payment.

13. The electronic apparatus of claim 11, wherein the processor is configured to limit at least some of the payment authentication method based on a user setting, and provide information related to a change in the user setting based on whether payment-related information satisfies the designated conditions.

14. A non-transitory computer-readable storage medium having stored thereon instructions that when executed by a processor executes a method of providing a payment service, wherein the method includes:
receiving a payment request input from a user terminal;
identifying whether the acquired payment request satisfies designated conditions, the designated conditions comprising a condition on whether the user terminal corresponds to an apparatus through which the user has performed the existing payment;
selecting a payment authentication method from a plurality of authentication methods based on whether payment-related information satisfies the designated conditions, wherein the plurality of authentication methods include a first authentication method and a second authentication method that includes an additional authentication procedure compared to the first authentication method, the additional authentication procedure configured to enhance security of the payment by receiving bio-information of the user;
obtaining a user input of the bio-information of the user via an interface screen in response to the second authentication method being selected;
providing payment completion information corresponding to the payment request in response to the first authentication method being selected;
transmitting a delivery request of the item in response to the providing of the payment completion information; and
performing a transaction procedure in response to the payment request based on a predetermined time elapsing after the providing of the payment completion information.

15. A computer-readable non-transitory recording medium on which a program allowing a computer to execute a method of providing a payment service is recorded, wherein the method includes:
acquiring a payment request for an item from a user;
identifying whether the acquired payment request satisfies designated conditions; and
omitting an additional authentication operation in response to the payment request satisfying the designated conditions, and providing payment completion information corresponding to the payment request.

16. (canceled)

17. The electronic apparatus of claim 11, wherein the processor is further configured to:
cancel the performing of the transaction procedure based on a cancellation request corresponding to the payment being received within the predetermined time; and
transmit a delivery cancellation request of the item in response to the reception of the cancellation request.

18. The electronic apparatus of claim 11, wherein the processor is further configured to provide a user interface allowing cancellation of the payment on at least some of content of the payment completion information for a set time.

19. The electronic apparatus of claim 11, wherein the designated conditions include a type condition of a payment means corresponding to the payment request.

20. The electronic apparatus of claim 11, wherein the processor is further configured to request the additional authentication in response to the payment request not satisfying at least some of the designated conditions.

21. The electronic apparatus of claim 11, wherein the designated conditions include at least one of an amount limit condition corresponding to the payment request or a risk determination condition of the payment.

22. The electronic apparatus of claim 21, wherein the risk determination condition includes a condition for at least one of type information regarding the item, information on a delivery destination corresponding to the payment request, or information regarding an apparatus that transmits the payment request.

23. The electronic apparatus of claim 20, wherein the processor is further configured to request a payment authentication using a personal identification number (PIN) or bio-information.

24. The electronic apparatus of claim 19, wherein the designated conditions include decision trees mapped to each type of the payment means.
